(19) United States
(12) Patent Application Publication
(10) Pub. No.: US 2004/0139623 A1
(43) Pub. Date: Jul. 22, 2004

(54) Radiation curing and drying

(76) Inventor: Leonard Immanuel Tafel, Mt. Prospect, IL (US)

Correspondence Address: LEONARD TAFEL, 1821 AZALEA LANE, MT. PROSPECT, IL, 60056, US

(21) Appl. No.: 10/693,054

(22) Filed: Oct. 25, 2003

Related U.S. Application Data
(60) Provisional application No. 60/421,337, filed on Oct. 25, 2002.

(51) Int. Cl. F26B 11/02

(52) U.S. Cl. 34/114

(57) ABSTRACT

An improved apparatus and method for drying materials. A hot surface in a strong electrostatic field is used to ionize a stream of heated gasses passing over the surface, which assists in directing the stream against the object to be dried, and ionizes the vapors and gasses emitted from surface of the material being dried, which assists in their separation and removal.

### BACKGROUND OF THE INVENTION

The present invention relates generally to the drying and setting of materials, and more particularly, but not limited to, the drying ink and paint coatings.

A variety of industrial, commercial and consumer goods require a solidification process, either removal of liquids contained in the structure of the goods, or a coating applied thereon, or by catalysis of the goods themselves or their coatings. Some materials require a curing process that may is usually initiated by the addition of some form of energy. In the case of many inks and coatings, the removal of some or all of the liquid portion to initiate solidification releases a large perfusion of fumes and vapors, many having known health risks. Commonly, a large volume of high-velocity heated air is directed at the surface, even though only a fraction of the air actually comes even near the surface, due to the difficulty in penetrating through the “boundary layer effect” of vapors and gasses near the surface. The countercurrent of fumes and vapors clinging to the surface also create a barrier against convective heating as well as preventing radiation from reaching the surface of the material to be dried.

Electrostatic precipitators generally will not remove gasses, so an odor would remain. Large high-pressure fans are required to even partially penetrate the boundary layer near the surface of the material, and once the blast of hot air, fume and vapors has left the surface it is not usually reused, but is “cleaned up” and exhausted into the atmosphere. Due to the huge volumes of air contaminated with vapors and fumes produced by this process, removal of the contaminants through incineration or high-temperature catalysis is expensive and wasteful, often doubling the energy expenditure of the initial drying operation. Water based coating drying systems, while not requiring as much “clean-up” of the effluent, still require substantial amounts of energy and process time due to the high latent h at of vaporization of water, thus slowing production rat s.

### SUMMARY OF THE INVENTION

The present invention discloses a drying system comprising: a blower that passes air over flames electrically charged to a high-voltage source, ionizing rods containing rows of pins, some of which are connected to ground and some to a high-voltage DC supply, and insulated strands of wire in the effluent stream for collecting the ionized fumes and solvents.

### BRIEF DESCRIPTION OF THE DRAWINGS

FIG. 1 shows a semi diagrammatic view of the system for drying one side of a continuous web using the concepts of this invention.

FIG. 2 shows a pictorial view of the invention showing an overall external view.

### DETAILED DESCRIPTION OF THE PREFERRED EMBODIMENT

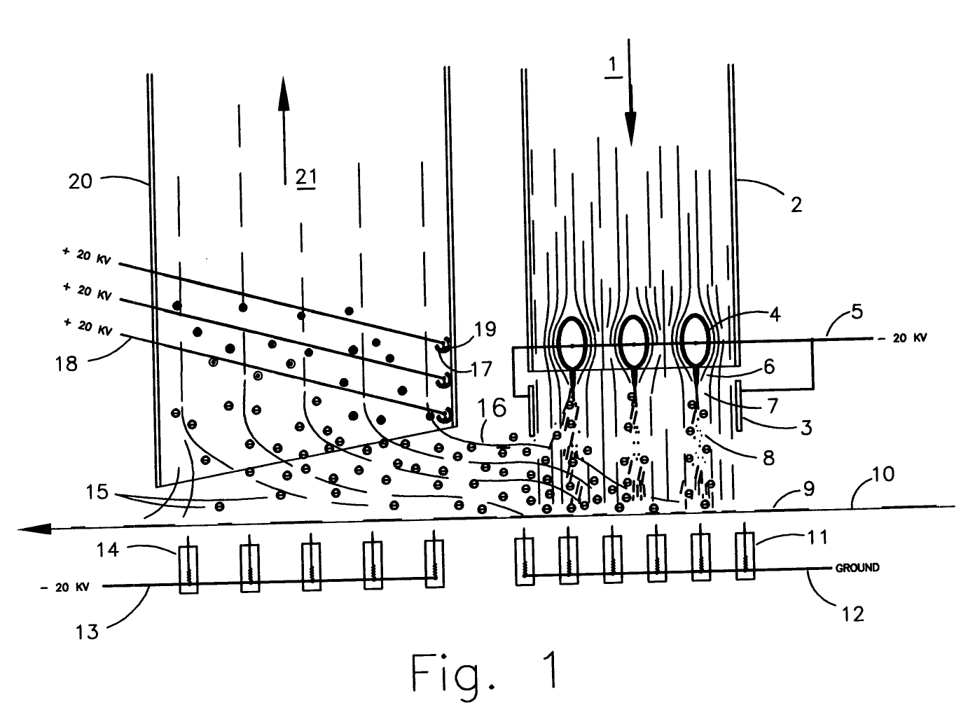

Referring now specifically to the drawings, FIG. 1 shows diagrammatically a drying system in accordance with the present invention. The purpose of the illustrated system is to rapidly dry and cure printing inks or coatings applied upstream on the web by a printing press or coater of common design and construction which is located upstream (not shown). Although the illustrations depict a paper web with uncured or wet printing ink applied thereto, the present method and apparatus will be understood to apply to objects of various shapes and compositions. These objects may themselves be solidified, dried of cured, or they may have a surface or internal coating to be altered. Inks, coatings, films and plastics may be formulated which are particularly susceptible to being selectively altered by the ultraviolet radiation and ozone produced by this system.

As illustrated in FIG. 1, the web enters from the right and passes under the outlet from duct 2 that encloses preheated air 1 descending past heated tubes 4 that are maintained at a high voltage negative potential by wire 5 connected from DC power supply to said tubes thereby causing an electrostatic field 8 between the flames 7 in serrated channel 6 to the web 10 and the ink image 9 applied thereto, and thence to charge bars 11 connected to the power supply ground by wire 12.

These heated tubes are referred to hereinafter as “charge tubes” and may or may not have flames emitting therefrom. “Charge bars” are elongated, insulated structures have exposed conductive surfaces from which an electrostatic charge emanates, usually in the form of a row of oxidation-resistant pins usually internally electrically interconnected. There are commercially available variations, some having the individual pins connected to a common bus by resistors, which serves to even out the electrostatic field and reduce arcing. They are usually constructed of an insulating material, and have an internal electrical connection from the conducting surfaces to a connection plug or terminal.

The flow of electrical current through said electrostatic field and web to the charge bars 11 creates additional heating added to the convective heat from the airstream 1, and said heating impinging on the web and the ink applied thereon, causes vaporization and oxidizing of some of the ink components. With sufficiently high voltage, a corona may be caused to occur on the surfaces being treated, which may solidify certain inks. Ozone may also be produced which may rapidly oxidize certain inks and coatings. The vapors and fumes 16 emanating from said web and ink into the electrostatic field acquire a charge. Convective movement away from the web by said fumes and vapors 16 is assisted by said acquisition of a negative charge 15, said charge causing them to be repelled from the surface of the web that now passes over negatively charged bars 14. Said fumes and vapors move into up into duct 20 by a combination of suction airstream 21 and repulsion from a negative charge on the plurality of charge bars 14, said bars being connected to the power supply by wire 13. The ionized vapors and fumes 16 are attracted to wires 18 that are at a positive high-voltage potential, said vapors and fumes adhering to said wires in the form of liquid and solids 19 that runs down said wires into receptacles 17 for removal and recycling. Special inks may be formulated that are particularly sensitive to exposure to electrons in the electrostatic field, said inks adhering to said web undergoing a reaction so disposed as to cause curing and solidification. Removal of the fumes and vapors attracted to wires 18 may be facilitated by wires that are formed into an endless belt, whereby said wires may be continuously cleaned by moving past a cleaning means such as a brush or scraper.

Although drying of only one side of a web is depicted, it is understood that by inverting or re-orienting the structures of the present invention, drying or curing my be effected on opposing sides of any object, the top and bottom of a web printed or coated on both sides in this instance.

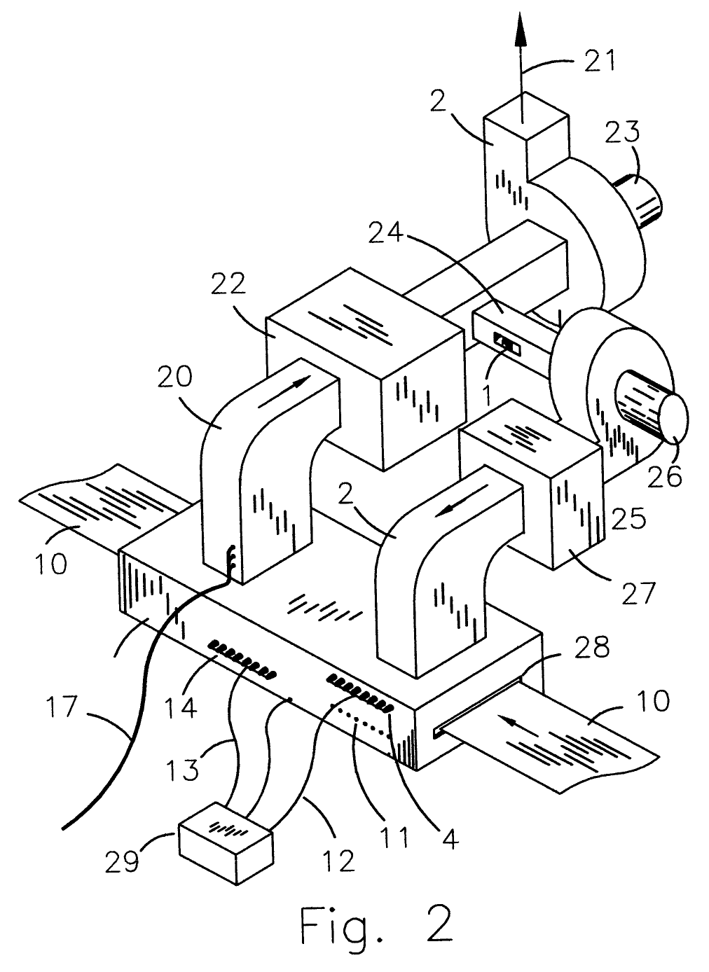

FIG. 2 shows the present invention in an overall view of the preferred embodiment for drying or curing the top of a web. Blower 25 driven by motor 26 draws environmental air into adjustable aperture 1 and expels said air through preheater 27, into duct 2 where it moves across ionizing bars 4 and impinges against the top of web 10 which enters housing 7 through elongated aperture 28. High-voltage supply 29 is connected by ground wire 12 to the housing. Insulated negative high-voltage wires 5 and 13 connect to the ionizing bars 4 and 14 respectively. Collector wires 18 (shown in FIG. 1) are connected to the positive high-voltage terminal of said power supply by insulated wire 24. Liquid captured from the airstream 21 is conveyed by drain tube 30 into an appropriate container. Remaining contaminants in the airstream 21 are removed by conventional filtering means 22. A potion of the air exiting from said filtering means is recycled into the inlet of blower 26 by duct 23.

1: A system to cause solidification at least in part comprising:
means for directing an airflow across a heated high-voltage structure so disposed as to provide thermionic emission, the ionized airflow being then attracted towards a plurality of elongated charge bars, said items to be at least in part solidified, being interposed between said high-voltage structures and said charge bars.

2: The system in claim 1 wherein said objects are moved into a second position wherein the ionized vapors and fumes emitted therefrom are repelled therefrom by a second charge bar, and attracted to a moving endless band, said band being continuously cleaned for collection of said vapors and fumes adhered thereto.

3: The system in claim 1 wherein the plurality of heated, high-voltage structures are coated with material that facilitates thermionic-emission, alkaline earth oxides being exemplary of said materials.

4: The system in claim 1 wherein electrically charged structures confine and direct said ionized airflow toward the items to be at least in part solidified.

5: The system in claim 1 wherein the high-voltage structures are perforated hollow tubes containing flammable gas under pressure, so disposed as to emit flames to facilitate ion-emission.

6: The system in claim 1 wherein said ionized airflow causes said fumes and vapors being emitted from said items to be at least in part solidified to become ionized, thereby facilitating removal of said fumes and vapors by electrostatic repulsion and attraction,

7: The system in claim 1 wherein said items to be at least in part solidified are moved to a second position where a second charge bar causes the ionized vapors and fumes emitted therefrom to be repelled away from said items to be at least in part solidified by an electrostatic field and attracted therefrom to a means for collection of said vapors and fumes.

8: The system in claim 1 wherein said items to be at least in part solidified are moved to a plurality positions where the ionized vapors and fumes emitted from said items, are repelled therefrom by an electrostatic field from a second charge bar and attracted to a means for collection of said vapors and fumes, each of said positions being interposed with said heated high voltage structures.

9: The system in claim 1 wherein said ionized vapors and fumes are caused undergo a chemical reaction wherein the molecules in said fumes and vapors react chemically to produce larger, heavier molecules.

10: The system in claim 1 wherein the items to be solidified are inks on the surface of a moving web of paper and
wherein the heated high-voltage structures consist of a plurality of spaced elongated tubes positioned parallel to the plane of said web and having the major axis of said tubes at a right angle to the direction of web travel,
said tubes being coated with a material that facilitates thermionic emission, and
opposed charge-bars so disposed that the web is interposed between said tubes and said charge bars,
said tubes being maintained at a sufficiently high temperature and electrical voltage potential so as to create an electrostatic field between said tubes and charge bars, thereby ionizing said airflow,
said ionized airflow impinging upon said web, thereby causing said ink on said web to become solidified and the fumes and vapors emitted from said ink to become ionized.

11: The device in claim 1 wherein a substantial portion of the airflow from which said fumes and vapors have been electrostatically cleaned are recirculated into the incoming airflow.

12: The system in claim 1 wherein said ionized vapors and fumes are caused undergo a chemical reaction wherein the ionized molecules in said fumes and vapors react chemically to form larger, heavier molecules through the use of catalysts.

13: The system in claim 1 wherein said ionized vapors and fumes are caused undergo a chemical reaction wherein the ionized molecules in said fumes and vapors are separated from said airstream and used to fuel an internal combustion engine.

14: A system for solidifying ink printed on a moving web of paper comprising:
a structure means for directing an airflow across a plurality of elongated and perforated hollow tubes at a high negative electrical potential,
said tubes also containing flammable gas under pressure, so disposed as to emit flames along the length of said tubes,
said tubes thereby becoming sufficiently heated so as to initiate thermionic-emission of ions from said tubes into said airstream, and
charge bars so disposed that said web is interposed between said charge bars and said tubes,
said ionized airstream being thereby attracted to the web interposed in the electrostatic field created between said tubes and said charge-bars, thereby causing ionization of said vapors and fumes as they are emitted from said web, and
means for collecting said ionized fumes and vapors.

15: The system in claim 14 wherein the voltage on the charge tubes is sufficient to cause a corona on the surface of the web, the ultraviolet energy causing the inks and coatings to become solidified.

16: The system in claim 14 wherein the voltage on the charge tubes is sufficient to create an ozone atmosphere at the surface of the web, thereby causing the inks and coatings to become solidified.

17: A system for solidifying ink printed on a moving web of paper comprising:
a structure means for directing an airflow across a plurality of a wire at a high negative electrical potential, said wires being coated with a substance known to facilitate thermionic-emission, and sufficiently heated so as to initiate thermionic-emission of ions from said wires into said airstream, and
charge bars so disposed that said web is interposed between said charge bars and said tubes,
said ionized airstream being thereby attracted to the web interposed in the electrostatic field created between said wires and said charge-bars, thereby causing ionization of said vapors and fumes as they are emitted from said web,
and a second position downstream in the direction of web travel wherein the ionized vapors and fumes emitted from the web are repelled therefrom by a second charge bar, and attracted to a collection means.
